(19) United States
(12) Patent Application Publication
(10) Pub. No.: US 2004/0124602 A1
(43) Pub. Date: Jul. 1, 2004

(54) Devices and equipment for biking upright

(76) Inventor: Pol Raikin, Akko (IL)

Correspondence Address: Pol Raikin, Hotel Argaman 65, P.O. Box 2680, Akko, 24126, IL

(21) Appl. No.: 10/330,227

(22) Filed: Dec. 30, 2002

(51) Int. Cl. B62M 1/14

(52) U.S. Cl. 280/221

(57) ABSTRACT

Devices and Equipment for Biking upright can be applied practically to any operator-powered vehicle (bicycle, tricycle, tandem, scooter, etc.) with the aim of increasing its operating parameters.

Devices include poles, fasteners and supports for biking upright, and should be installed on the vehicle's forepart.

Equipment includes a driving gear mechanism with a chain drive that has a pedal cartridge, and a mechanism that returns the pedal levers to their initial position. The Equipment provides pedaling on a vehicle in upright as well as in sitting position. Biking upright allows the cyclist to use not only-his leg muscles, but also his body and hands muscles, and it also allows the cyclist to use his weight in time of need. A scooter, which uses the described equipment, will be comfortable to travel on both on roads and sidewalks.

### BACKGROUND OF THE INVENTION

1. Field of the Invention

The present invention relates to individual transport means and more particularly to operator powered vehicle such as a bicycle, tricycle, tandem bicycle, scooter and to accompanying sets and devices as well as to sporting devices and trainer simulators.

2. Description of the Related Art

In all the variety of available operator powered vehicles special attention should be paid to those enabling activation of the greatest number of strong groups of human muscles (for example bicycle disclosed in Russian Pat. No. 1.698.123, 3/1993, Raikin, Int. Cl. B62K 3/00), and also activation of the cyclist weight during riding (refer for example to U.S. Pat. No. 4,349,566, 4/1983, Titcomb, U.S. Cl. 280/251 Int. Cl. B62K 21/18 or to the scooter disclosed in U.S. Pat. No. 6,273,439 B1. 8/2001 Ray et. al, U.S. Cl. 280/87/041 Int., Cl. B62M 1/00). However, the solutions mentioned above did not gain significant prevalence as a day-to-day transport means, first of all because of inadequate level of their operational functionality. The reason was the absent of additional sets and devices for the human powered vehicle, which could have allow cyclist alternate straightening up of his spine during riding upright while using his physical possibilities in the most efficient manner by combing the effort of his numerous strong muscles and his body weight. The lack of mentioned designs or auxiliary devices restrains improvement of operational functionality of the human powered vehicle and to use it as a day-to-day transport means. None of the above inventions and patents, taken either singly or in combination, is seen to describe the instant invention as claimed Kamen's motor vehicle “Segway Human Transporter” could have been used as a daily transportation mean. But it is very heavy and expensive, and its operating characteristics are limited in many respects. An acceptable construction with poles might be “Devices Set For Motor less Vehicle for Biking Upright” (application Ser. No. 10/107,187 for U.S. patent). Both of the solutions mentioned above do not exclude the possibility of future improvements.

### SUMMARY OF THE INVENTION

The aim of the present invention is to extend the possible use of vehicle as a day-to-day transport means and simultaneously as physical training and fitness tool, significantly improving its functional parameters (power, velocity, distance of riding) without substantial design complications and increase of weight, dimensions and cost. The above aim is attained through more efficient use of the efforts of the muscles, body and weight of the cyclist, as well as by the possibility to change the position of the cyclist (upright or sitting) for giving rest to one muscle group while loading other muscle groups. Accordingly, it is a principle object of the invention to create a possibility of mass using of an operator powered vehicle as a day to day transportation mean for traveling both on roads and sidewalks.

In order to realize the objects of this invention, Devices and Equipment for Biking Upright consists of (and/or):

A crossbar, intended for installation on the frame of the vehicle near the handlebar, in order to support the poles, and a paddy bar, intended for installation on the handle bar for contacting the poles;

A crossbar, fulfilled as paddy;

A crossbar, fulfilled as folding;

A paddy bar, fulfilled in the shape of a fork (a hook), which envelopes the shank of the pole;

Poles for the hands of the cyclist;

An operator powered vehicle with a power chain-drive, which includes a pedal cartridge, which has two overrunning clutches for the pedal levers and a mechanism, which returns the pedal levers to their initial position;

A vehicle, the mechanism for returning the pedal levers to their initial position of which contains springs;

A vehicle, the mechanism for returning the pedal levers to their initial position of which contains clips, which are put on the driver's shoes;

A vehicle, wherein magnetized plates are installed on the clips and the pedals;

A vehicle, particularly a scooter, which contains: a driving gear mechanism with a chain drive that has a pedal cartridge and a mechanism that returns the pedal levers to their initial position, as well as a slack sprocket, which is installed on the bush of the rear wheel;

A vehicle, particularly a scooter, which contains a convertible (rotating) seat that is installed above the rear wheel;

The above-described vehicles are equipped by two overrunning clutches for the pedal levers and a mechanism, which returns the pedal levers to their initial position, in order to enable the forward-back movement instead of the circular motion of the pedals. This enables a more comfortable pedaling both in upright and sitting positions. A convertible seat allows traveling in seating position, i.e. changing the character of the cyclist's movements at his discretion.

### 3. SHORT DESCRIPTION OF DRAWINGS

The essence of the invention is explained by drawings on which components of devices and equipment for biking upright are shown together with their installation variants on the vehicle.

FIG. 1 shows a bicycle, on which devices for biking upright are installed.

FIG. 2 shows the above view of this bicycle.

FIG. 3 shows the components of the devices for biking uptight when installed directly on the frame of the bicycle.

FIG. 4 shows a supporting pole for the cyclist's hands.

FIG. 5 shows components of the devices for biking upright, which are installed on the handle bar.

FIG. 6 shows a bicycle, equipped, by a pedal cartridge, which is specially intended for biking upright and a return spring, which returns the pedals to their initial position.

FIG. 7 shows the placing of the right spiral spring as a construction variant of a return spring.

FIG. 8 shows a variant of a return mechanism, when magnetized plates are used.

FIG. 9 shows a variant of a return mechanism, when using clips for the legs of the cyclist.

FIG. 10 shows a scooter with a pedal cartridge for biking upright or biking in a sitting position.

### DETAILED DESCRIPTION OF THE DEVICE

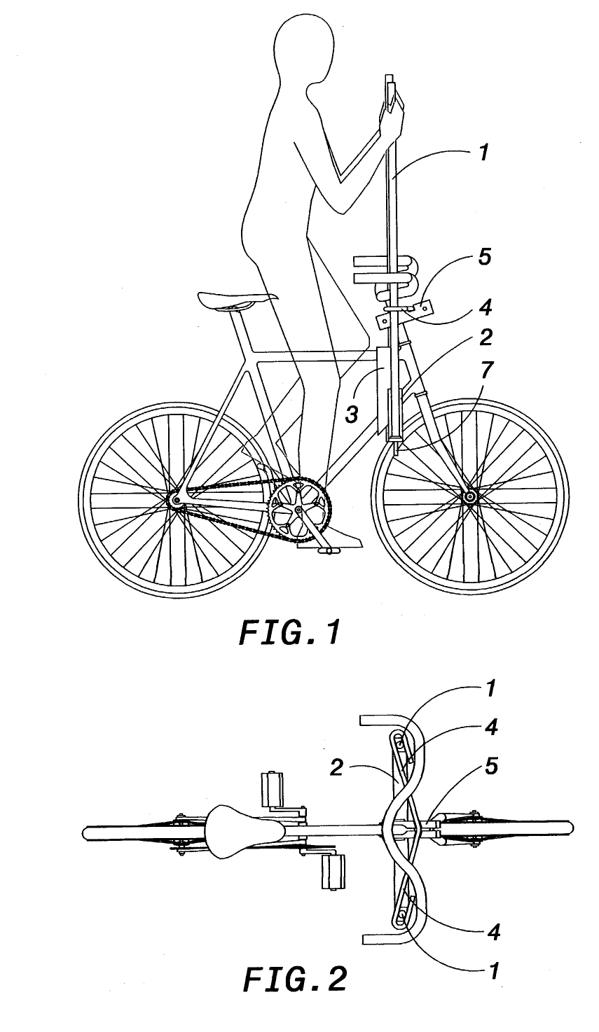

On FIG. 1 and FIG. 2 support poles 1 for the cyclist's hands are shown. The poles are supported by crossbar 2, which is installed with the help of cramp 3, which is hung on the upper pipe of the frame of an ordinary bicycle. On the handle bar leg, paddy bar 4, which encloses the shanks of poles 1 by its ends, is installed. Paddy bar 4 is fixed on the handle bar with the help of two straps 5, which are interconnected by bolts.

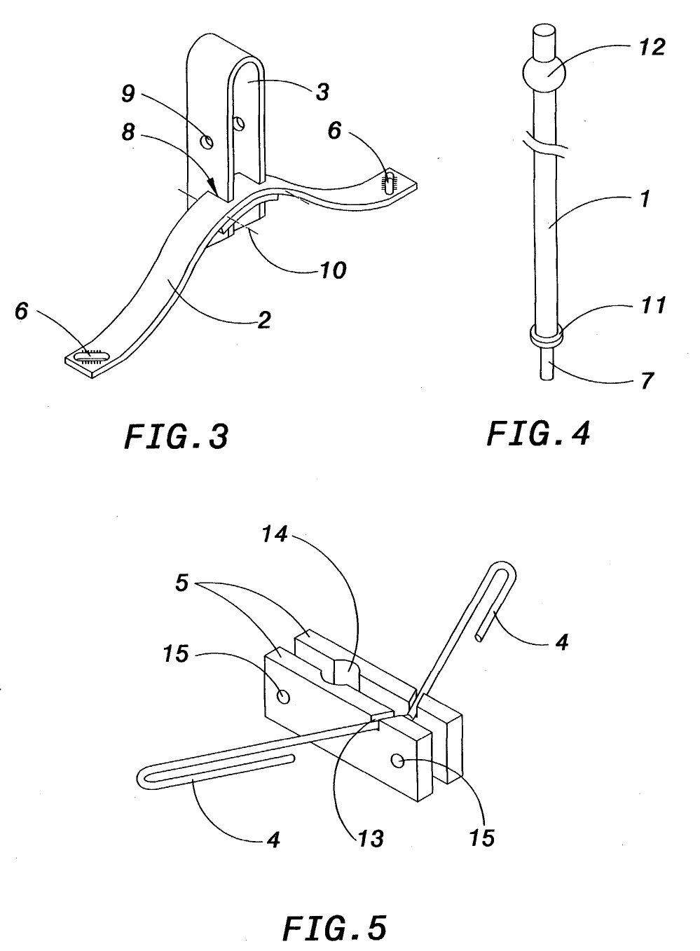

FIG. 3 shows crossbar 2 as a leaf spring, when ends 7 (FIG. 4) of poles 1 are inserted into slots 6. Crossbar 2 is installed into-slits 8 of cramp 3. The upper edge of crossbar 2 rests against the bicycle frame (FIG. 1). Cramp 3 is tightened by a bolt, which passes through hole 9. The crossbar can be made folding. In this case its ends rise up around hinges with axles 10.

FIG. 4 shows pole 1 with support ring 11, which is supported by crossbar 2. Thickening 12 on the pole's handle serves for convenient tightening up of the-cyclist's body.

FIG. 5 shows bar 4, which is made of a thick and paddy wire, inserted into slits 13 of straps 5. Fashions 14 of straps 5 are enclosing the handle bar leg. Through holes 15 of straps 5 passes bolts, which tighten the straps. Bar 4 can be made of two independent halves—right and left. In this case, each half is fixed on its part of the handle bar: The ends of bar 4 have the shape of a hook, which encloses pole 1. The ends of bar 4 can be straight as well as fork shaped.

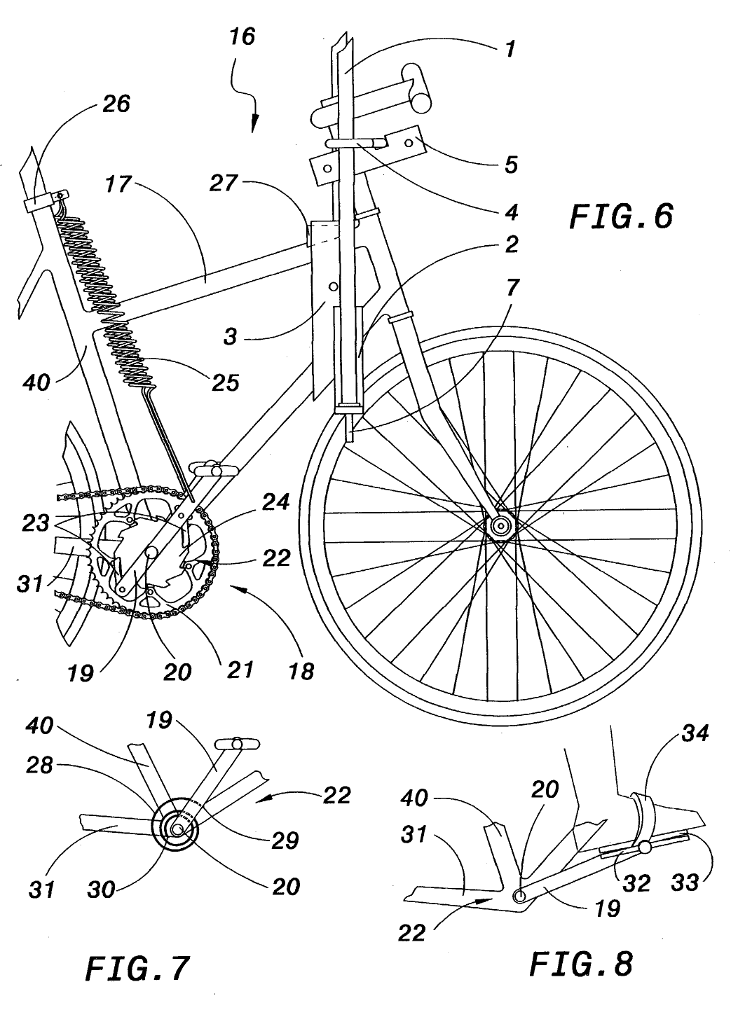

FIG. 6 shows bicycle 16 with inclined upper pipe 17 of the frame and with special pedal cartridge 18, which provides the swinging (forward-back movement) of pedal levers 19. These levers are installed on axis 20 of the cartridge with the possibility of sliding. Drive sprocket 21 of the driving gear mechanism is rigidly installed on axis 20. The work incline of levers 19 is passed to axis 20 and to sprocket 21 by the help of overrunning clutches 22, found on each lever. Ratchet pawls 23 are installed on the levers. The ratchet pawls are engaged with ratchet-wheels 24, which are rigidly connected to axis 20. Other variants of overrunning clutches can also be used here. The ratchet variant of mechanism 22 is shown for pictorial presentation of the general idea. The return of levers 19 with the pedals to their initial position is done with the help of two tension springs 25, the lower ends of which are connected to the levers, and the upper ends of which are fixed on the frame with the help of bangle 26. The incline of upper pipe 17 of the frame is compensated by bush 27, which is installed under cramp 3.

FIG. 7 shows right pedal lever 19 with spiral spring 28 that returns the pedal to its initial position. A lever supports outer end 29 of the spring, while inner end 30 is supported by the frame of the bicycle near lower fork 31 of the rear wheel. In the same way, on the left, around axis 20, a second spiral spring, which returns the pedal to its initial position, is installed. Instead of using spiral springs 28, as another variant, torsion coil springs may be used. Overrunning clutches 22 of levers 19 and sprocket 21 are not shown on FIG. 7. They were shown on FIG. 6.

FIG. 8 shows a construction variant for returning the pedals, which uses magnetized plates 32 that are installed on the pedals, and plates 33 that are fixed using clips (crosspieces) 34 on the cyclist's shoes. Plates 32 and 33 are magnetized one to another and follow the foot of the cyclist. Sprocket 21 and overrunning clutches 22 are not shown on FIG. 8.

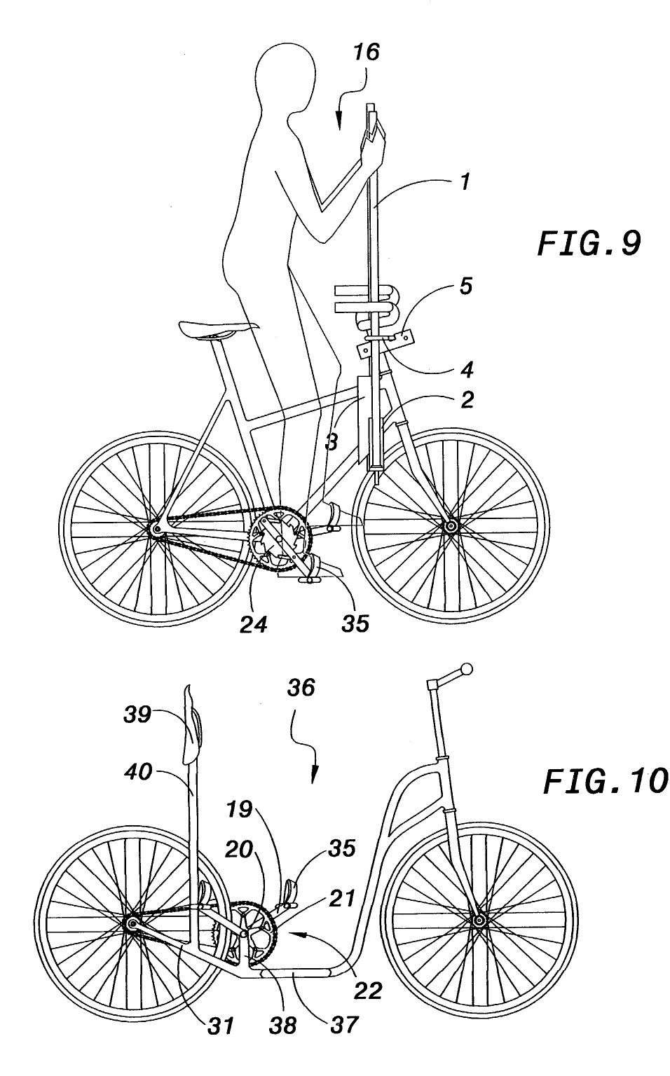

FIG. 9 shows a possibility of using clips 35 for returning the pedals to their initial position. Ratchet wheel 24 of right overrunning clutch 22 is also shown.

FIG. 10 shows scooter 36 with the above-described pedal cartridge 18 and clips 35 on the pedals. Here, the upright biking is provided by using platform 37 for the left foot of the driver (scooter variant) as well as by using pedal cartridge 18, installed on prop 38 on the lower pipe of the frame (bicycle variant). A chain drive, which is similar to the bicycle's one, is placed on the left side of the scooter. This mechanism, which also includes cartridge 18, allows the driver to bike upright just like on a bicycle (FIG. 9), while his hands are holding the handle bar or to bike while seating on convertible seat 39, which is installed on pipe 40 of the frame. For biking upright (scooter variant) the driver turns right pedal lever 19 to the back, as shown on FIG. 10. Such a construction of a scooter has wide possibilities of practical application.

While the present has been described with what is considered the most practical and preferred embodiment, it is to be understood that the present invention is not limited to the sole embodiment described above, but encompasses any and all embodiments within the scope of the following claims.

I claim:

1. Devices and Equipment for Biking Upright, containing a bicycle, further comprising:
poles, which are supports for the hands of an upright cyclist;
a crossbar, which is the support for said poles, and is rigidly installed on the bicycle's frame, near the bicycle's handle-bar;
a spring bar, which is installed on the handle-bar for getting in touch with the poles.

2. Devices as recited in claim 1, wherein the crossbar is made springy.

3. Devices as recited in claim 1, wherein the crossbar is fulfilled as folding.

4. Devices as recited in claim 1, wherein the spring bar has hooked ends.

5. Devices and Equipment for Biking Upright containing a scooter, further comprising:
a driving gear mechanism with a chain transmission having a driving sprocket and a driven sprocket, which is rigidly installed on a bush of a scooter's rear wheel;
pedal levers, wherein each pedal lever is connected to said driving sprocket by means of their own overrunning clutch;
a mechanism that returns the pedal levers to their initial position.

6. Devices, as recited in claim 5, wherein a convertible seat is installed on the scooter's frame above the rear wheel.
